(19) United States
(12) Patent Application Publication
(10) Pub. No.: US 2008/0224353 A1
(43) Pub. Date: Sep. 18, 2008

(54) Hydraulic Valve of Molding System

(75) Inventor: Gregory Allan Schultz, Bolton (CA)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, CA

(73) Assignee: Husky Injection Molding Systems Ltd., Bolton (CA)

(21) Appl. No.: 11/685,820

(22) Filed: Mar. 14, 2007

(51) Int. Cl. B29C 45/00

(52) U.S. Cl. 264/328.1; 137/625.48; 425/562

(57) ABSTRACT

Disclosed is: (i) a molding system having a hydraulic valve, (ii) a molding system having: (a) an extruder, (b) a hydraulic circuit, and (c) a hydraulic valve, (iii) a hydraulic valve of a molding system, (iv) a method of a molding system having a hydraulic valve, and (v) a valve controller performing a method of a molding system having a hydraulic valve. The hydraulic valve includes: (i) a valve sleeve that is configured to convey a pressurized hydraulic fluid, and (ii) a valve spool that is movable relative to the valve sleeve, once the valve spool is made to move from a valve-closed position to a valve-opened position, the valve spool is imparted with a running start before the pressurized hydraulic fluid is permitted to flow out of the valve sleeve.

### TECHNICAL FIELD

The present invention generally relates to, but is not limited to, molding systems, and more specifically the present invention relates to, but is not limited to: (i) a molding system having a hydraulic valve, (ii) a molding system having: (a) an extruder, (b) a hydraulic circuit, and (c) a hydraulic valve, (iii) a hydraulic valve of a molding system, (iv) a method of a molding system having a hydraulic valve, and (v) a valve controller performing a method of a molding system having a hydraulic valve.

### BACKGROUND

Examples of known molding systems are (amongst others): (i) the HyPET (trademark) Molding System, (ii) the Quadloc (trademark) Molding System, (iii) the Hylectric (trademark) Molding System, and (iv) the HyMET (trademark) Molding System, all manufactured by Husky Injection Molding Systems (www.husky.ca).

U.S. Pat. No. 3,578,025 (Inventor: Furrer; Published: May 11, 1971) discloses a fluid-controlled slide valve arrangement, in particular a pneumatically or hydraulically controlled slide valve arrangement, for alternately connecting an outflow conduit with a pressure conduit and return flow conduit of a fluid-operating system. This slide valve arrangement embodies a sleeve valve member displaceably mounted in a slide valve housing, such sleeve valve member incorporating at one end a piston extension of larger diameter. Fluid-operated control means alternately apply a pneumatic or hydraulic overpressure to the end faces of the piston extension in order to displace the sleeve valve member. The pneumatic or hydraulic control overpressure is only maintained during a portion of the switching operation. Relief channel means provided at the slide valve arrangement communicate with the outside, whereby the control pressure drops during the latter part of the switching operation as soon as the relief channel means are freed by the enlarged piston extension.

U.S. Pat. No. 4,211,255 (Inventor: Wisbey et al.; Published: Jul. 8, 1980) discloses a slide valve has a spool valve element that is moved unidirectionally to a sequence of three positions during its operating cycle. The valve structure and unidirectional motion of the spool provide a precompression of the fluid being handled. The valve structure also permits relief of excess downstream pressure. Preferably hydraulic liquid is used to drive, position, and reset the spool valve. The spool valve itself has a hollow body with one groove on its outside surface and a valve body with a port at one end that is always in communication with the hollow portion of the spool valve. The slide valve is especially designed for and preferably used in a liquid reaction molding system to direct a reagent between a source (e.g. reservoir) and a destination (e.g. a mixing head). When applied to such a reaction molding system each slide valve replaces three conventional ball valves and one check valve and yet provides the additional features of precompression and relief of excess pressure.

U.S. Pat. No. 4,938,118 (Inventor: Wolfges et al.; Published: Jul. 3, 1990) discloses a 3/2 proportional control valve is provided with an actuating piston which is subjected to the control pressure set in a pilot valve. The area relationships of the actuating piston are so chosen that at the actuating piston a high pressure gradient obtains and the adjustment dynamics of the regulating piston are increased.

U.S. Pat. No. 4,951,703 (Inventor: Brehm et al.; Published: Aug. 28, 1990) discloses an electromagnetic valve includes a housing which accommodates an armature and a spool and separates them from the hydraulic valve part of the valve. The housing includes a tubular casing made by deep drawing or extrusion molding and flanged at two ends thereof to form two end flanges which extend inwardly of the housing to enclose parts positioned in the housing. A tubular sleeve which serves as a spacer abuts against the inner peripheral face of the casing.

U.S. Pat. No. 5,445,188 (Inventor: Bourkel et al.; Published: Aug. 29, 1995) discloses a pilot-operated servo valve design for efficient mounting in a control block has at least three main-stream ports. An opening into a control sleeve for a first main-stream port is disposed opposite an end surface of a main control piston. The main control piston has a pressure-equalizing surface disposed in a pressure-equalizing chamber, which is fluidically coupled by a pressure-equalizing duct in the main control piston to the first main-stream port. A return spring urges the main control piston toward a first axial end stop to clearly define a safety position.

U.S. Pat. No. 5,896,890 (Inventor: Bourkel et al.; Published: Apr. 27, 1999) discloses a pilot controlled servo-valve has four main flow connections, an axially sliding main control piston with four control edges and a front restoring spring that defines a spring-centered middle position of the main control piston. A control sleeve has ring shaped openings for the first, second and third main flow connections and a front opening for the fourth main flow connection. A first front face of the main control piston is axially opposed to the front opening. A pressure compensation surface is formed by the second front face of the main control piston in a spring chamber. The main control piston applies the pressure in the fourth main flow connection on said pressure compensating surface through a pressure relief channel. A traverse bore connects said pressure relief channel to an auxiliary connection chamber connected to the third main flow connection by the forth control edge. This valve may be space-savingly integrated in a hydraulic block and has a clearly defined middle position, as well as a remarkable dynamic performance.

U.S. Pat. No. 6,598,622 (Inventor: Reith et al.; Published: Jul. 29, 2003) discloses a directional control valve which has a movable control piston which separates two pressure chambers from each other in the valve housing interior, which pressure chambers can be subjected to control pressure in order to move the control piston into axial positions corresponding to relevant switch positions of the valve in accordance with the difference in pressure prevailing between the control chambers. An arrangement acts on the control piston, produces an actuating force and prestresses the control piston for movement into an axial position corresponding to a desired predetermined position.

U.S. Pat. No. 6,789,570 (Inventor: Beyrak et al.; Published: Sep. 14, 2004) discloses a hydraulic valve with a position sensor is described. According to various implementations, the valve has a cage with a set of radial holes, a spool assembly slideable within the cage, and a sensor, which may be a Hall effect sensor, that reacts to the movement of the spool assembly. In other implementations, the spool comprises one or more of the following: a spool, a pin that is mechanically coupled to the spool, a dampener, which may be a spring, having a first and a second end, the first end being in contact with the pin and the second end being in contact with the spool.

FIGS. 1A and 1B are cross-sectional views of a known hydraulic valve 1 of a molding system (not depicted). The known hydraulic valve 1 includes a valve sleeve 2 and a valve spool 10 that is slidable along the valve sleeve 2. The sleeve 2 defines a passageway 4 that leads from a first port 6 to a second port 8. The valve spool 10 has an end face 11. The first port 6 is connected to a hydraulic circuit (not depicted) so as to receive a pressurized hydraulic fluid. The second port 8 is connected to a hydraulic actuator (not depicted, such as a screw actuator of an extruder). A valve controller 18 is connected to the valve spool 10 so as to actuatably position the valve spool 10 between a valve-closed position (as depicted in FIG. 1A) and a valve-opened position (as depicted in FIG. 1B). In the valve-closed position, the end face 11 is positioned proximate of (preferably, adjacent to) the second port 8 so as to block flow of the hydraulic fluid from the input port 6 to the output port 8. In the valve-opened position, the end face 11 is positioned so as to uncover the output port 8, and responsive to uncovering the output port 8, at least in part, the hydraulic fluid may flow from the input port 6 to the output port 8. The hydraulic fluid flows along a path 20.

### SUMMARY

According to a first aspect of the present invention, there is provided a molding system, having: a hydraulic valve, including: (i) a valve sleeve being configured to convey a pressurized hydraulic fluid; and (ii) a valve spool being movable relative to the valve sleeve, once the valve spool is made to move from a valve-closed position to a valve-opened position, the valve spool is imparted with a running start before the valve spool permits flow of the pressurized hydraulic fluid from the valve sleeve.

According to a second aspect of the present invention, there is provided a molding system, having: (I) an extruder, including: (i) a hopper configured to receive a moldable material; (ii) a feed throat connecting to the hopper so as to receive the moldable material from the hopper; (iii) a barrel defining a channel, the channel connecting to the feed throat so as to receive the moldable material from the feed throat; (iv) a screw being placed in the channel; (v) a screw actuator connecting to the screw, the screw actuator configured to move the screw so that the moldable material is converted into an injectable molding material; (II) a hydraulic circuit configured to provide a pressurized hydraulic fluid; and (III) a hydraulic valve, including: (i) a valve sleeve being configured to convey the pressurized hydraulic fluid from the hydraulic circuit to the screw actuator; and (i) a valve spool being movable relative to the valve sleeve, once the valve spool is made to move from a valve-closed position to a valve-opened position, the valve spool is imparted with a running start before the valve spool permits flow of the pressurized hydraulic fluid from the valve sleeve.

According to a third aspect of the present invention, there is provided a method of a molding system having a hydraulic valve including: (i) a valve sleeve being configured to convey a pressurized hydraulic fluid, and (ii) a valve spool being movable relative to the valve sleeve, the method, including: an operation of moving the valve spool from a valve-closed position to a valve-opened position, the valve spool is imparted with a running start before the valve spool permits flow of the pressurized hydraulic fluid from the valve sleeve.

According to a fourth aspect of the present invention, there is provided a valve controller performing a method of a molding system having a hydraulic valve including: (i) a valve sleeve being configured to convey a pressurized hydraulic fluid, and (ii) a valve spool being movable relative to the valve sleeve, the method, including: an operation of moving the valve spool from a valve-closed position to a valve-opened position, the valve spool is imparted with a running start before the valve spool permits flow of the pressurized hydraulic fluid from the valve sleeve.

According to a fifth aspect of the present invention, there is provided a hydraulic valve of a molding system, the hydraulic valve including (i) a valve sleeve being configured to convey a pressurized hydraulic fluid, and (ii) a valve spool being movable relative to the valve sleeve, once the valve spool is made to move from a valve-closed position to a valve-opened position, the valve spool is imparted with a running start before the valve spool permits flow of the pressurized hydraulic fluid from the valve sleeve.

A technical effect, amongst other technical effects, of the aspects of the present invention is improved operation of the molding system, and specifically improved operation of the screw of the extruder, and even more specifically of improved injection operation of the screw.

### DESCRIPTION OF THE DRAWINGS

A better understanding of the non-limiting embodiments of the present invention (including alternatives and/or variations thereof) may be obtained with reference to the detailed description of the non-limiting embodiments of the present invention along with the following drawings, in which:

FIGS. 1A and 1B are the cross-sectional views of the known hydraulic valve 1 of the molding system (not depicted);

FIG. 2 depicts a schematic representation of a hydraulic valve 200, a hydraulic valve 300, or a hydraulic valve 400 of a molding system 100 according to a first non-limiting embodiment;

FIGS. 3A and 3B depict cross-sectional views of the hydraulic valve 200 according to a second non-limiting embodiment;

FIG. 4 depicts a schematic representation of a method 160 of a valve controller 118 used to control the hydraulic valve 200, the hydraulic valve 300, or the hydraulic valve 400 according to a third non-limiting embodiment;

FIGS. 5A and 5B depict cross-sectional views of the hydraulic valve 300 according to a fourth non-limiting embodiment;

FIGS. 6A, 6B depict schematic representations of the hydraulic valve 400 according to a fifth non-limiting embodiment;

FIGS. 7A, 7B depict cross-sectional views of the hydraulic valve 400 according to the fifth non-limiting embodiment; and

FIGS. 8 and 9 depict performance attributes of the hydraulic valve 400 according to the fifth non-limiting embodiment compared to the performance attributes of the known hydraulic valve 1.

The drawings are not necessarily to scale and are sometimes illustrated by phantom lines, diagrammatic representations and fragmentary views. In certain instances, details that are not necessary for an understanding of the embodiments or that render other details difficult to perceive may have been omitted.

### DETAILED DESCRIPTION OF THE NON-LIMITING EMBODIMENTS

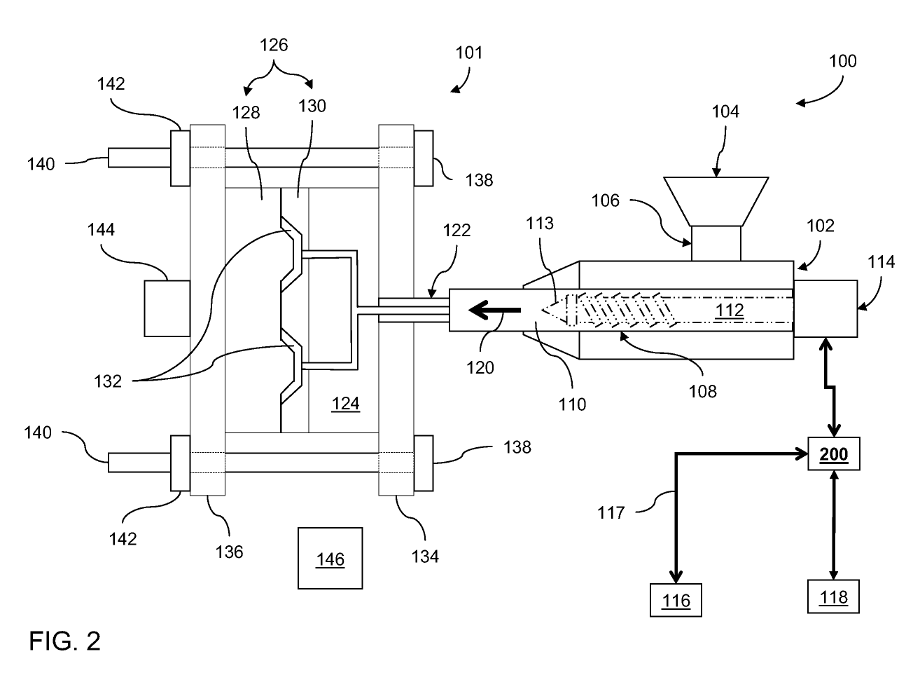

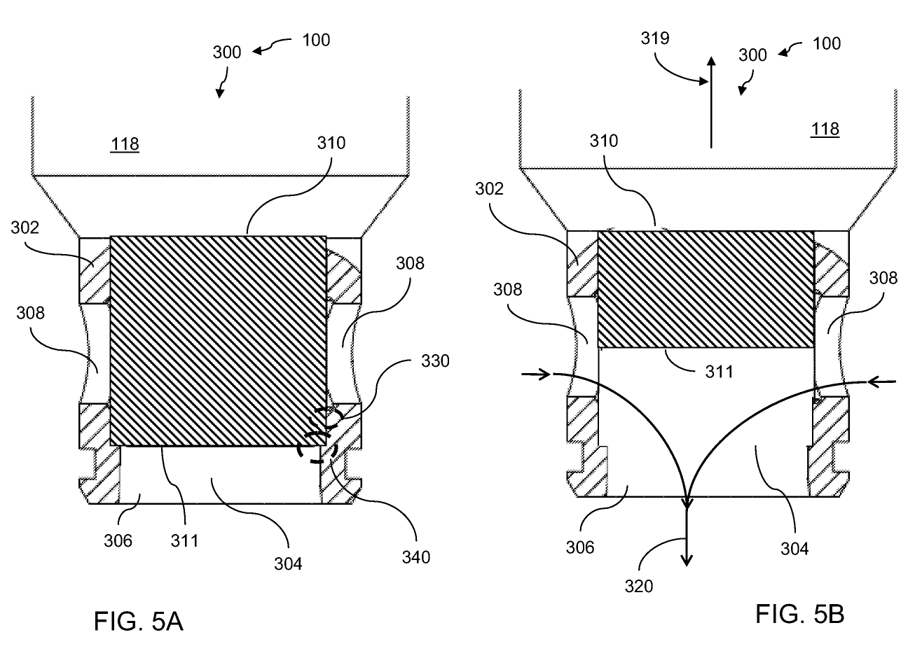

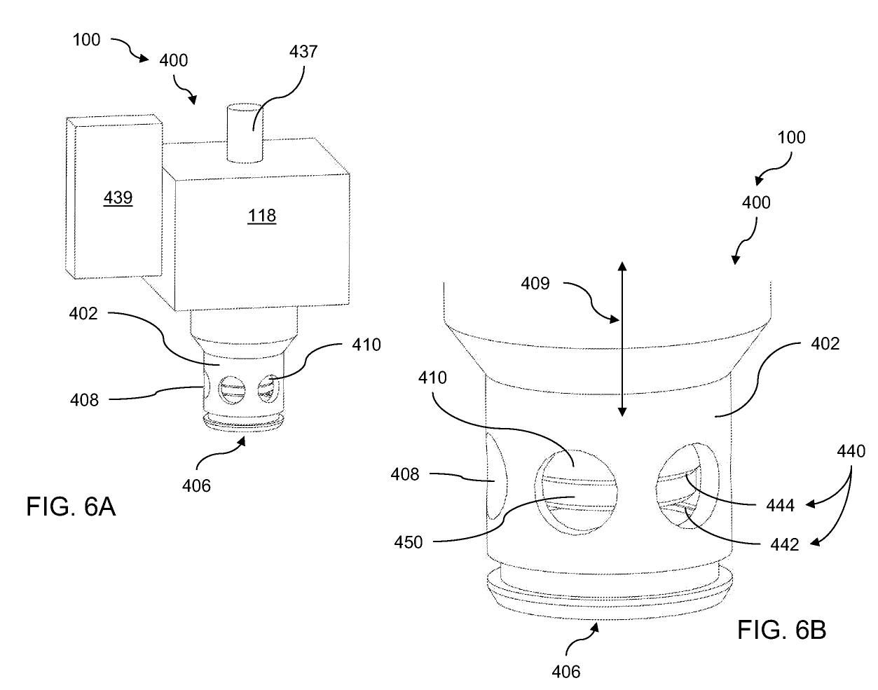

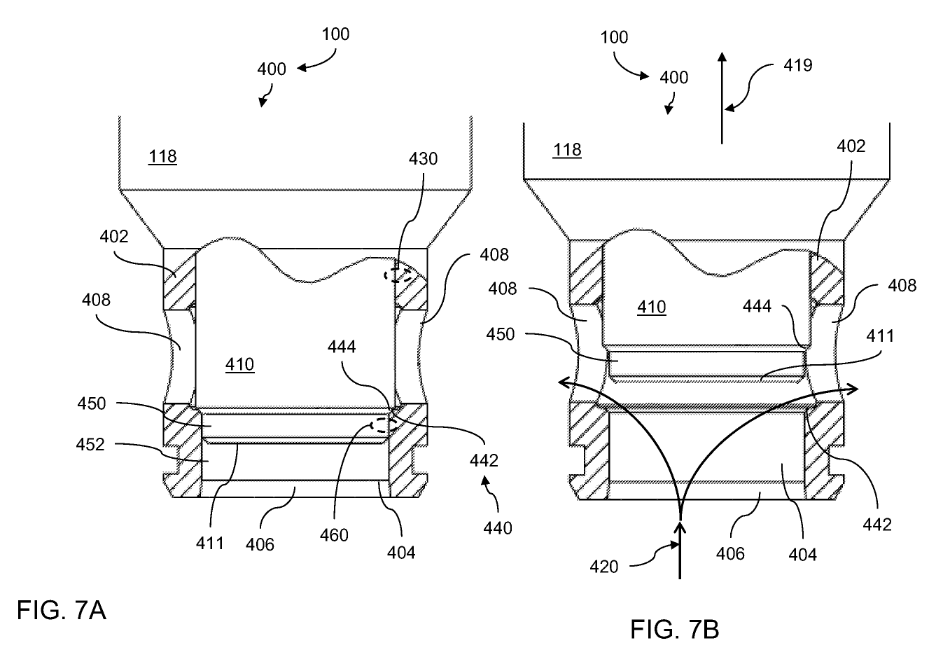

FIG. 2 depicts the schematic representation of the hydraulic valve 200 of the molding system 100 according to the first non-limiting embodiment. The molding system 100 includes, for example, an injection molding system, and the molding system 100 is hereafter referred to as the “system 100”. The system 100 includes some components that are known to persons skilled in the art and these known components will not be described here but are described, at least in part, in the following text books (by way of example): (i) Injection Molding Handbook by Osswald/Turng/Gramann (ISBN: 3-446-21669-2; publisher: Hanser), and (ii) Injection Molding Handbook by Rosato and Rosato (ISBN: 0-412-99381-3; publisher: Chapman & Hill). The system 100 includes: (i) an extruder 102, (ii) a hydraulic circuit 116, and (iii) the hydraulic valve 200. Described below are three non-limiting embodiments of a hydraulic valve, which are: (i) the hydraulic valve 200 as depicted in FIGS. 2, 3A, 3B and 4, (ii) the hydraulic valve 300 as depicted in FIGS. 5A, 5B, and (iii) the hydraulic valve 400 as depicted in FIGS. 6A, 6B, 7A and 7B. By way of a non-limiting example, the extruder 102 may be: (i) a reciprocating-screw (RS) extruder, (ii) a two-stage (TS) extruder that has a shooting pot configuration, or (iii) other suitable configuration. According to the first non-limiting embodiment as depicted in FIG. 2, the extruder 102 includes: (i) a hopper 104, (ii) a feed throat 106, (iii) a barrel 108, (iv) a screw 112, and (v) a hydraulic actuator 114. The hopper 104 receives, in use, a moldable material, such as pellets of either a plastic material or a metallic alloy. The feed throat 106 connects to the hopper 104 so as to receive the moldable material from the hopper 104. The barrel 108 defines a channel 110 that is connected to the feed throat 106 so that the channel 110 may receive the moldable material from the feed throat 106. The screw 112 is placed in the channel 110 of the barrel 108. The screw 112 is configured to be rotated (by an electrical motor, which is not depicted) so as to: (i) transform the moldable material that is held in the barrel 108 into an injectable moldable material (by frictional heating in the case where pellets of plastic material are used as the moldable material), and (ii) accumulate a shot of the injectable molding material in an accumulation zone located in front of a check valve 113 that is connected to the front section of the screw 112. In the case where the pellets of metallic alloy are used as the moldable material, the screw 112 does not add a sufficient amount of frictional heating to the pellets of metallic alloy, and the primary way of heating the pellets of metallic alloys is by using heaters attached to the barrel 108. The hydraulic actuator 114 is: (i) connected to the screw 112, and (ii) used to linearly translate the screw 112 so as to inject, under pressure, the shot of (accumulated) injectable molding material into a mold cavity 132 defined by a mold assembly 126. During injection of the injectable molding material from the barrel 108, the check valve 113 prevents backflow of the injectable molding material toward the hopper 104. The hydraulic circuit 116 provides or conveys, in use, a pressurized hydraulic fluid 117 to the hydraulic actuator 114 so as to actuate the hydraulic actuator 114 and cause injection of the injectable molding material from the barrel 108.

According to the non-limiting embodiment as depicted in FIG. 2, the system 100 further includes a clamp assembly 101, which has: (i) a stationary platen 134, (ii) a movable platen 136, (iii) tie bars 140, (iv) clamps 138, and (v) locks 142. The stationary platen 134 supports a hot runner 124. The hot runner 124 is connected to and supports a stationary mold portion 130 of a mold assembly 126. The movable platen 136 is configured to support a movable mold portion 128 of the mold assembly 126. The movable platen 136 is movable relative to the stationary platen 134 so as to close the movable mold portion 128 relative to the stationary mold portion 130. The movable mold portion 128 and the stationary mold portion 130 define the mold cavity 132 once the movable mold portion 128 and the stationary mold portion 130 are made to abut each other. The mold assembly 126 is typically sold separately from the system 100. The clamps 138 are supported at respective corners of the stationary platen 134. The locks 142 are supported at respective corners of the movable platen 136. The tie bars 140 extend from respective clamps 138 to respective locks 142. The locks 142 are used to lock and unlock the tie bars 140 relative to the respective corners of the movable platen 136. A machine nozzle 122 connects the extruder 102 to the hot runner 124 so that the injectable molding material may flow from the extruder 102, through the hot runner 124 and into the mold cavity 132. It will be appreciated that the machine nozzle 122, the mold assembly 126 and the hot runner 124 are items that are sold separately from the clamp assembly 101, the extruder 102, and the system 100. Sometimes the machine nozzle 122 is supplied with the extruder 102. A molded article 146 is manufactured by the system 100.

In operation, the platens 134, 136 are stroked so as to close the mold assembly 126, and then the tie bars 140 are locked to the movable platen 136, the clamps 138 are actuated so as to impart a clamping force to: (i) the stationary platen 134, and (ii) the tie bars 140 and in response the tie bars 140 transmit the clamping force to the movable platen 136. In this manner, the clamping force becomes transmitted to the mold assembly 126. Then, the extruder 102 injects the injectable molding material into the mold cavity 132 defined by the mold assembly 126. Once the molded article 146 has formed in the mold cavity 132, the clamps 138 are deactivated and a mold break force is applied to the mold assembly 126 so as to break apart the mold portions 128, 130. Then the platens 134, 136 are stroked apart and the molded article 146 is removed from the mold assembly 126 either manually or by a robot (not depicted).

According to a variant (not depicted) of the first non-limiting embodiment, (i) the hot runner 124 is not included, (ii) the stationary platen 134 supports the stationary mold portion 130, and (iii) the machine nozzle 122 connects the extruder 102 to the movable mold portion 128, so that after the movable mold portion 128 and the stationary mold portion 130 have been closed together and the clamps 138 have been actuated, the injectable molding material may flow from the extruder 102, through the machine nozzle 122 and into the mold cavity 132.

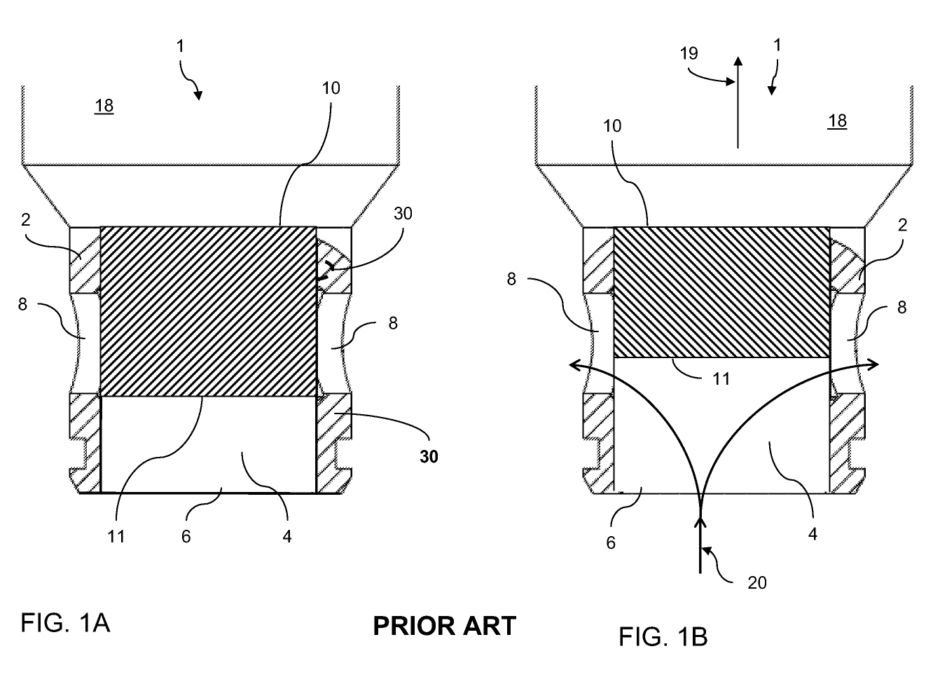

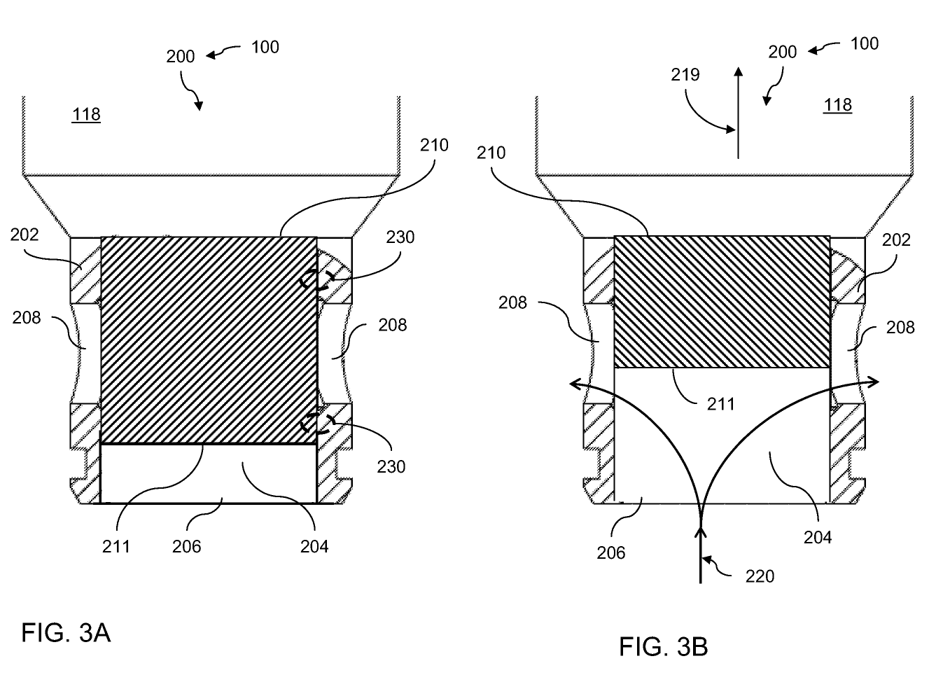

FIGS. 3A and 3B depict the cross-sectional views of the hydraulic valve 200 according to the second non-limiting embodiment, in which the hydraulic valve 200 includes: (i) a valve sleeve 202, and (ii) a valve spool 210. The valve sleeve 202 is configured to convey the pressurized hydraulic fluid 117 (from the hydraulic circuit 116 to the hydraulic actuator 114 once the valve sleeve 202 is connected in such a manner to do so). The valve spool 210 is movable within the valve sleeve 202 between a valve-closed position (as depicted in FIG. 3A) and a valve-opened position (as depicted in FIG. 3B) responsive to becoming actuated to move by, for example, a valve controller 118. Once the valve spool 210 is made to move from the valve-closed position to the valve-opened position, the valve spool 210 is imparted with a running start before the valve spool 210 permits flow of the pressurized hydraulic fluid 117 from the valve sleeve 202. In this manner, the valve spool 210 passes by a port (either one of a first port 206 or a second port 208) at a greater-than-zero speed so as to get out of the way quicker (relative to the speed by which the valve spool 10 of the hydraulic valve 1 of FIG. 1 is made to move past the first port 6 or the second port 8) so that the hydraulic fluid 117 flows quicker to the hydraulic actuator 114 in sharp contrast to the operation of the hydraulic valve 1 of FIG. 1. The valve sleeve 202 defines a passageway 204 that extends between the first port 206 and the second port 208. The first port 206 and the second port 208 are defined by the valve sleeve 202. Specifically, an end face 211 of the valve spool 210 obtains the running start before the pressurized hydraulic fluid 117 is permitted to flow from the first port 206 to the second port 208 (or between the ports 206, 208). In the valve-closed position, (i) the valve spool 210 blocks flow of the pressurized hydraulic fluid 117 between the first port 206 and the second port 208, and (ii) the end face 211 is offset from the second port 208 (so that the valve spool 210 blocks the second port 208). The first port 206 is connected to the hydraulic circuit 116, and the second port 208 is coupled or connected to a hydraulic actuator 114. The hydraulic circuit 116 conveys (or provides) the pressurized hydraulic fluid 117 to the first port 206, and the hydraulic actuator 114 is actuated responsive to receiving the pressurized hydraulic fluid 117 from the second port 208. Once the hydraulic fluid 117 is made to flow, the hydraulic fluid 117 will travel along a path 220 that extends from the first port 206 to the second port 208. The valve spool 210 travels along a direction 219 that extends along the axis of the valve spool 210 from the first port 206 to the second port 208. Between the valve sleeve 202 and the valve spool 210 there is a sliding seal 230 that is configured to substantially prevent leakage of the hydraulic fluid 117 between the valve sleeve 202 and the valve spool 210. According to a variant (not depicted), the second port 208 receives, in use, the pressurized hydraulic fluid 117 from the hydraulic circuit 116, and the first port 206 is coupled to the hydraulic actuator 114.

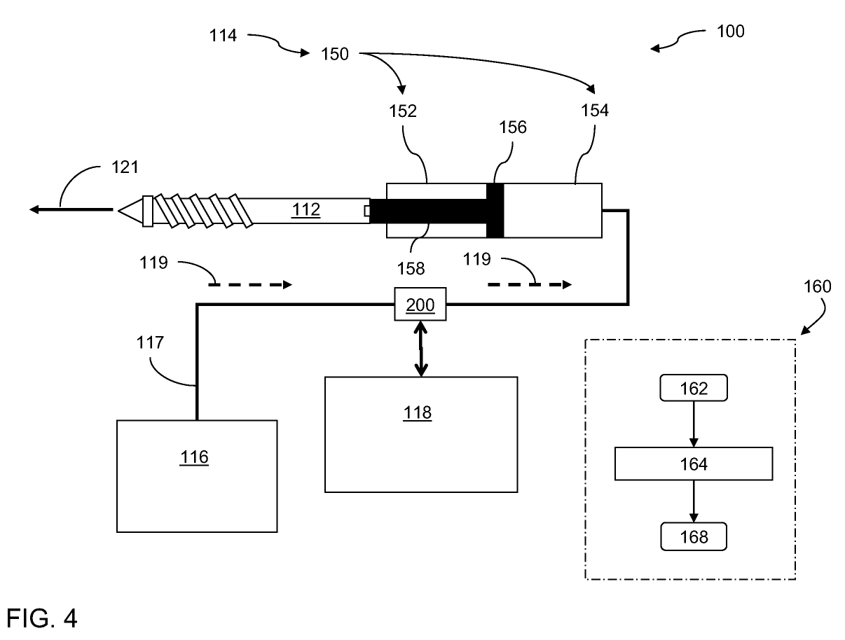

FIG. 4 depicts the schematic representation of the method 160 of the valve controller 118 used to control any one of the hydraulic valves 200, 300 or 400 according to the third non-limiting embodiment. The valve controller 118 is coupled to the valve spool 210 of the hydraulic valve 200. The method 160 of the valve controller 118 includes an operation 164 of moving the valve spool 210 from the valve-closed position to the valve-opened position so that the valve spool 210 is imparted with a running start before the valve spool 210 permits flow of the pressurized hydraulic fluid 117 from the valve sleeve 202. The hydraulic actuator 114 includes a cylinder 150 that has a rod side 152 and a bore side 154. Disposed in the cylinder 150 are a piston 156 and a rod 158 that is attached to the piston 156. The piston 156 is slidable along the inside of the cylinder 150 between the rod side 158 and the bore side 154. The rod 158 extends from the piston 156 through the rod side 152 and out of the cylinder 150. The screw 112 is connected to a distal end of the rod 158. The valve 200 is operated so as to permit the hydraulic fluid 117 to move along a direction 119 quicker (relative to the operation of the hydraulic valve 1 of FIG. 1) so that the screw 112 may be moved quicker along a direction 121.

FIGS. 5A and 5B depict the cross-sectional views of the hydraulic valve 300 according to the fourth non-limiting embodiment. To facilitate an understanding of the fourth non-limiting embodiment, elements of the fourth non-limiting embodiment (that are similar to those of the second non-limiting embodiment as depicted in FIGS. 3A and 3B) are identified by reference numerals that use a three-hundred designation rather than a two-hundred designation (as used in the second non-limiting embodiment). According to the fourth non-limiting embodiment, the hydraulic valve 300 includes: (i) a valve sleeve 302 that is configured to convey the pressurized hydraulic fluid 117 (once the valve sleeve 302 is connected to do so), and (ii) a valve spool 310 that is movable relative to the valve sleeve 302. Once the valve spool 310 is made to move from the valve-closed position (as depicted in FIG. 5A) to the valve-opened position (as depicted in FIG. 5B), the valve spool 310 is imparted with a running start before the valve spool 310 permits flow of the pressurized hydraulic fluid 117 from the valve sleeve 302. Specifically, the valve spool 310 includes an end face 311. The valve sleeve 302 and the end face 311 of the valve spool 310 define a face seal 340. Between the valve sleeve 302 and the valve spool 310 there is a sliding seal 330. In the valve-closed position, the valve sleeve 302 abuts the end face 311 of the valve spool 310 at the face seal 340. In the valve-opened position, the end face 311 of the valve spool 310 is offset from the face seal 340. Once the hydraulic fluid 117 is made to flow, the hydraulic fluid 117 will travel along a path 320 that extends from the second port 308 to the first port 306 (that is, the second port 308 is the input port and the first port 306 is the output port). The valve spool 310 travels along a direction 319 that extends along the axis of the valve spool 310 from the first port 306 to the second port 308.

FIGS. 6A, 6B depict the schematic representations of a hydraulic valve 400 according to the fifth non-limiting embodiment. To facilitate an understanding of the fifth non-limiting embodiment, elements of the fifth non-limiting embodiment (that are similar to those of the second non-limiting embodiment as depicted in FIGS. 3A and 3B) are identified by reference numerals that use a four-hundred designation rather than a two-hundred designation (as used in the second non-limiting embodiment). According to the fifth non-limiting embodiment, the hydraulic valve 400 includes a valve sleeve 402 and a valve spool 410 that is slidable within the valve sleeve 402. The valve sleeve 402 defines a first port 406 and also defines a second port 408. A valve controller 118 is connected to the valve spool 410 and is used to control movement of the valve spool 410. A pilot valve 439 is used to assist in the valve controller 118 in the movement of the valve spool 410. FIG. 6B depicts an axis of motion 409 of the valve spool 410. The valve spool 410 includes a spigot 450 that extends axially from the end of the valve spool 410. The valve sleeve 402 defines a sleeve seat 442. Between the spigot 450 and the valve spool 410 there is defined a spool face seat 444. Both the spool face seat 444 and the sleeve face seat 442 are collectively called a face seal 440.

FIGS. 7A, 7B depict the cross-sectional views of the hydraulic valve 400 according to the fifth non-limiting embodiment. The hydraulic valve 400 includes: (i) a valve sleeve 402 that is configured to convey the pressurized hydraulic fluid 117, and (ii) a valve spool 410 that is movable relative to the valve sleeve 402. Once the valve spool 410 is made to move from the valve-closed position (as depicted in FIG. 7A) to the valve-opened position (as depicted in FIG. 7B), the valve spool 410 is imparted with a running start before the valve spool 410 permits flow of the pressurized hydraulic fluid 117 from the valve sleeve 402. According to the fifth non-limiting embodiment, the valve sleeve 402 includes a spigot-receiving space 452 that sealably slidably receives the spigot 450. The end face 411 of the valve spool 410 defines a face seal 440. There is, between the spigot 450 and the spigot-receiving space 452, a spigot sliding seal 460. The face seal 440 includes: (i) a sleeve face seat 442 on an inner surface of the valve sleeve 402, and (ii) a spool face seat 444 on an outer surface of the spigot 450. It is preferred to chamfer the edges of the seals. By way of example, the travel of the valve spool 410 is fourteen millimeters (mm), and the length of the spigot 450 is five millimeters (mm).

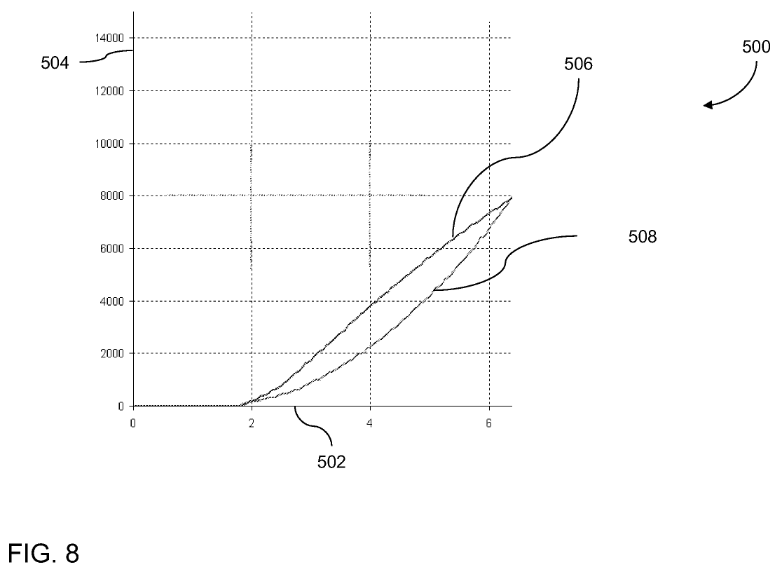

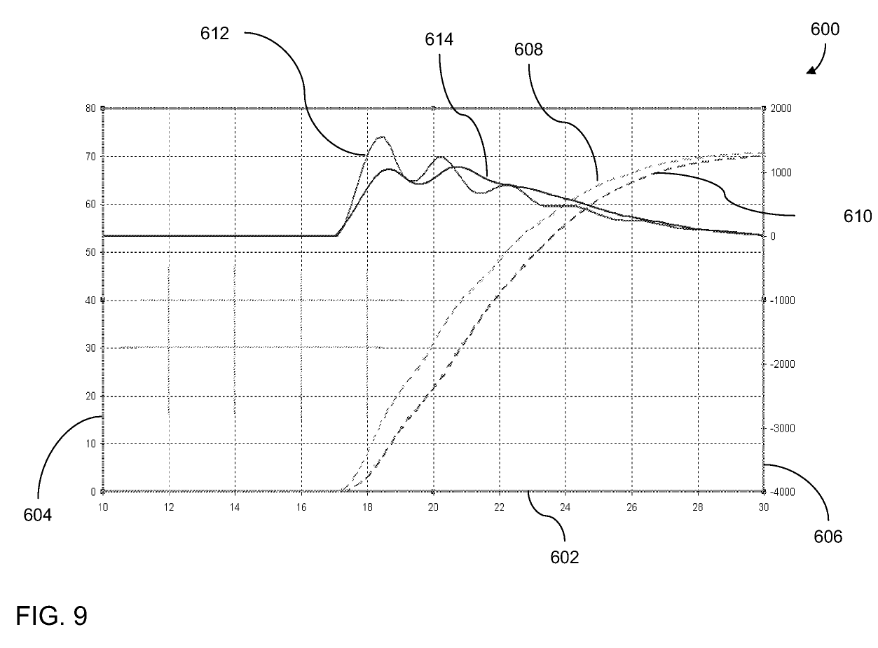

FIGS. 8 and 9 depict performance of the hydraulic valve 400 according to the fifth non-limiting embodiment compared to the performance of the known hydraulic valve 1 of FIG. 1. Specifically, FIG. 8 depicts a graph 500 showing a melt flow versus time of injectable molding material that is made to flow from the extruder 102 to the mold cavity 132 of the mold assembly 126, using the hydraulic valve 400 and the known hydraulic valve 1. The graph 500 includes: (i) a horizontal axis 502 that indicates time in milliseconds (hereafter referred to as “ms”), and (ii) a vertical axis 504 that indicates flow of the injectable molding material in cubic centimeters per second (hereafter referred to as “cc/s”). A curve 506 shows flow of the injectable molding material as a result of using the hydraulic valve 400 (of FIGS. 7A and 7B). A curve 508 shows flow of the injectable molding material as a result of using the known hydraulic valve 1 (of FIGS. 1A and 1B). Clearly, by using the hydraulic valve 400, there is a technical effect achieved that is desirable in view of the known hydraulic valve 1; namely: the hydraulic valve 400 achieves a faster flow for the injectable molding material.

Specifically, FIG. 9 depicts a graph 600 showing speed versus time and showing acceleration versus time of the injectable molding material using the hydraulic valve 400 and the known hydraulic valve 1. The graph 600 includes: (i) a horizontal axis 602 that indicates time in milliseconds (hereafter referred to as “ms”), (ii) a vertical axis 604 that indicates speed of the injectable molding material in millimeters per second times one hundred (hereafter referred to as “mm/s×100”), and (iii) a vertical axis 606 that indicates acceleration of the injectable molding material in meters per second squared (hereafter referred to as mm/s²). A curve 608 shows speed of the injectable molding material as a result of using the hydraulic valve 400. A curve 610 shows speed of the injectable molding material as a result of using the known hydraulic valve 1. A curve 612 shows acceleration of the injectable molding material as a result of using the hydraulic valve 400. A curve 614 shows acceleration of the injectable molding material as a result of using the known hydraulic valve 1. By using the hydraulic valve 400, there is a technical effect achieved that is desirable in view of the known hydraulic valve 1; namely: the hydraulic valve 400 achieves a faster speed and acceleration for the injectable molding material.

The description of the non-limiting embodiments provides examples of the present invention, and these examples do not limit the scope of the present invention. It is understood that the scope of the present invention is limited by the claims. The non-limiting embodiments described above may be adapted for specific conditions and/or functions, and may be further extended to a variety of other applications that are within the scope of the present invention. Having thus described the non-limiting embodiments, it will be apparent that modifications and enhancements are possible without departing from the concepts as described. It is to be understood that the non-limiting embodiments illustrate the aspects of the invention. Reference herein to details of the illustrated embodiments is not intended to limit the scope of the claims. The claims themselves recite those features regarded as essential to the present invention. Preferable embodiments of the present invention are the subject of dependent claims. Therefore, what is to be protected by way of letters patent are limited only by the scope of the following claims:

What is claimed is:

1. A molding system, comprising:
a hydraulic valve, including:
a valve sleeve being configured to convey a pressurized hydraulic fluid; and
a valve spool being movable relative to the valve sleeve, once the valve spool is made to move from a valve-closed position to a valve-opened position, the valve spool is imparted with a running start before the valve spool permits flow of the pressurized hydraulic fluid from the valve sleeve.

2. A molded article manufactured by the molding system of claim 1.

3. The molding system of claim 1, wherein the valve sleeve defines a passageway extending between a first port to a second port.

4. The molding system of claim 1, wherein the valve spool includes:
an end face, the valve spool being slidably sealable along a passageway extending between a first port to a second port defined by the valve sleeve, once the valve spool is made to move along the passageway from the valve-closed position to the valve-opened position, the end face obtains the running start before the pressurized hydraulic fluid is permitted to flow between the first port and the second port.

5. The molding system of claim 1, wherein the valve spool includes:
an end face, the valve spool being slidably sealable along a passageway extending between a first port to a second port defined by the valve sleeve, once the valve spool is made to move along the passageway from the valve-closed position to the valve-opened position, the end face obtains the running start before the pressurized hydraulic fluid is permitted to flow between the first port and the second port, and
in the valve-closed position, the valve spool blocks flow of the pressurized hydraulic fluid between the first port and the second port, and the end face is offset from the second port.

6. The molding system of claim 1, wherein:
the valve spool includes:
an end face, the valve spool being slidably sealable along a passageway extending between a first port to a second port defined by the valve sleeve, once the valve spool is made to move along the passageway from the valve-closed position to the valve-opened position, the end face obtains the running start before the pressurized hydraulic fluid is permitted to flow between the first port and the second port; and
the molding system further comprises:
a hydraulic circuit configured to provide the pressurized hydraulic fluid to the first port; and
a hydraulic actuator configured to actuate responsive to receiving the pressurized hydraulic fluid from the second port.

7. The molding system of claim 1, wherein:
the valve spool includes:
an end face, the valve spool being slidably sealable along a passageway extending between a first port to a second port defined by the valve sleeve, once the valve spool is made to move along the passageway from the valve-closed position to the valve-opened position, the end face obtains the running start before the pressurized hydraulic fluid is permitted to flow between the first port and the second port; and
the molding system further comprises:
a hydraulic circuit configured to provide the pressurized hydraulic fluid to the first port; and
a hydraulic actuator configured to actuate responsive to receiving the pressurized hydraulic fluid from the second port, the hydraulic actuator being configured to move a screw of an extruder.

8. The molding system of claim 1, wherein:
the valve spool includes:
an end face, the valve spool being slidably sealable along a passageway extending between a first port to a second port defined by the valve sleeve, once the valve spool is made to move along the passageway from the valve-closed position to the valve-opened position, the end face obtains the running start before the pressurized hydraulic fluid is permitted to flow between the first port and the second port; and
the molding system further comprises:
a hydraulic circuit configured to provide the pressurized hydraulic fluid to the second port; and
a hydraulic actuator configured to actuate responsive to receiving the pressurized hydraulic fluid from the first port.

9. The molding system of claim 1, wherein:
the valve spool includes:
an end face, the valve spool being slidably sealable along a passageway extending between a first port to a second port defined by the valve sleeve, once the valve spool is made to move along the passageway from the valve-closed position to the valve-opened position, the end face obtains the running start before the pressurized hydraulic fluid is permitted to flow between the first port and the second port; and
the molding system further comprises:
a hydraulic circuit configured to provide the pressurized hydraulic fluid to the second port; and
a hydraulic actuator configured to actuate responsive to receiving the pressurized hydraulic fluid from the second port, the hydraulic actuator being configured to move a screw of an extruder.

10. The molding system of claim 1, wherein the valve spool includes:
an end face, the valve spool being slidably sealable along a passageway extending between a first port to a second port defined by the valve sleeve, once the valve spool is made to move along the passageway from the valve-closed position to the valve-opened position, the end face obtains the running start before the pressurized hydraulic fluid is permitted to flow between the first port and the second port, and
once the end face passes by, at least in part, the second port, the pressurized hydraulic fluid may flow from the first port to the second port.

11. The molding system of claim 1, wherein the valve spool includes:
an end face, the valve spool being slidably sealable along a passageway extending between a first port to a second port defined by the valve sleeve, once the valve spool is made to move along the passageway from the valve-closed position to the valve-opened position, the end face obtains the running start before the pressurized hydraulic fluid is permitted to flow between the first port and the second port, and
once the end face passes by, at least in part, the first port, the pressurized hydraulic fluid may flow from the second port to the first port.

12. The molding system of claim 1, wherein:
the valve sleeve defines a passageway extending between a first port to a second port,
the first port is configured to receive, in use, the pressurized hydraulic fluid from a hydraulic circuit,
the passageway is configured to receive, in use, the pressurized hydraulic fluid from the first port to the second port, and
the second port is configured to: (i) couple to a hydraulic actuator, the hydraulic actuator being configured to operatively couple to a screw being disposed in an extruder, and convey the pressurized hydraulic fluid to the hydraulic actuator.

13. The molding system of claim 1, wherein:
the valve sleeve defines a passageway extending between a first port to a second port,
the second port is configured to receive, in use, the pressurized hydraulic fluid from a hydraulic circuit,
the passageway is configured to receive, in use, the pressurized hydraulic fluid from the second port to the first port, and
the first port is configured to: (i) couple to a hydraulic actuator, the hydraulic actuator being configured to operatively couple to a screw being disposed in an extruder, and convey the pressurized hydraulic fluid to the hydraulic actuator.

14. The molding system of claim 1, wherein:
the valve spool includes an end face, and
the valve sleeve and the end face of the valve spool define a face seal.

15. The molding system of claim 1, wherein:
the valve spool includes an end face,
the valve sleeve and the end face of the valve spool define a face seal, and
the valve sleeve and the valve spool include a sliding seal.

16. The molding system of claim 1, wherein:
the valve spool includes an end face,
the valve sleeve and the end face of the valve spool define a face seal,
the valve sleeve and the valve spool include a sliding seal,
in the valve-closed position, the valve sleeve abuts the end face of the valve spool at the face seal, and
in the valve-opened position, the end face of the valve spool is offset from the face seal.

17. The molding system of claim 1, wherein:
the valve spool includes:
a spigot having an end face.

18. The molding system of claim 1, wherein:
the valve spool includes:
a spigot having an end face; and
the valve sleeve includes:
a spigot-receiving space configured to sealably receive the spigot, and the end face of the valve spool defines a face seal.

19. The molding system of claim 1, wherein:
the valve spool includes:
a spigot having an end face; and
the valve sleeve includes:
a spigot-receiving space configured to sealably receive the spigot, the end face of the valve spool defines a face seal, and the spigot and the spigot-receiving space define a spigot sliding seal.

20. The molding system of claim 1, wherein:
the valve spool includes:
a spigot having an end face, and
the valve sleeve includes:
a spigot-receiving space configured to sealably receive the spigot, and
the end face of the valve spool defines a face seal, the face seal includes:
a sleeve face seat on an inner surface of the valve sleeve; and
a spool face seat on an outer surface of the spigot.

21. The molding system of claim 1, wherein:
the valve spool includes:
a spigot having an end face; and
the valve sleeve includes:
a spigot-receiving space configured to sealably receive the spigot,
the end face of the valve spool defines a face seal, the face seal includes:
a sleeve face seat on an inner surface of the valve sleeve; and
a spool face seat on an outer surface of the spigot, and
the spigot and the spigot-receiving space define a spigot sliding seal.

22. A molding system, comprising:
an extruder, including:
a hopper configured to receive a moldable material;
a feed throat connecting to the hopper so as to receive the moldable material from the hopper;
a barrel defining a channel, the channel connecting to the feed throat so that the channel may receive the moldable material from the feed throat;
a screw being placed in the channel;
a hydraulic actuator connecting to the screw, the hydraulic actuator configured to move the screw so that the moldable material is converted into an injectable molding material;
a hydraulic circuit configured to provide a pressurized hydraulic fluid; and
a hydraulic valve, including:
a valve sleeve being configured to convey the pressurized hydraulic fluid from the hydraulic circuit to the hydraulic actuator; and
a valve spool being movable relative to the valve sleeve, once the valve spool is made to move from a valve-closed position to a valve-opened position, the valve spool is imparted with a running start before the valve spool permits flow of the pressurized hydraulic fluid from the valve sleeve.

23. The molding system of claim 22, further comprising:
a clamp assembly, including:
a stationary platen configured to support a stationary mold portion of a mold assembly;
a movable platen configured to support a hot runner, the hot runner configured to connect to a movable mold portion of the mold assembly, the movable platen being movable relative to the stationary platen so as to close the movable mold portion relative to the stationary mold portion, and the movable mold portion and the stationary mold portion define a mold cavity once the movable mold portion and the stationary mold portion are made to abut each other;
tie bars extending from the stationary platen to the movable platen, the tie bars being fixedly attached relative to the stationary platen, and the tie bars being lockable relative to the movable platen;
clamps configured to impart a clamping force to the movable platen and to the stationary platen once the tie bars have been locked to the movable platen; and
a machine nozzle connects the extruder to the hot runner so that the injectable molding material may flow from the extruder, through the hot runner and into the mold cavity.

24. The molding system of claim 22, further comprising:
a clamp assembly, including:
a stationary platen configured to support a stationary mold portion of a mold assembly;
a movable platen configured to support a movable mold portion of the mold assembly, the movable platen being movable relative to the stationary platen so as to close the movable mold portion relative to the stationary mold portion, and the movable mold portion and the stationary mold portion define a mold cavity once the movable mold portion and the stationary mold portion are made to abut each other;
tie bars extending from the stationary platen to the movable platen, the tie bars being fixedly attached relative to the stationary platen, and the tie bars being lockable relative to the movable platen;
clamps configured to impart a clamping force to the movable platen and to the stationary platen once the tie bars have been locked to the movable platen; and
a machine nozzle connects the extruder to the movable mold portion so that the injectable molding material may flow from the extruder to the mold cavity.

25. A molded article manufactured by the molding system of claim 22.

26. A method of a molding system having a hydraulic valve including: (i) a valve sleeve being configured to convey a pressurized hydraulic fluid, and (ii) a valve spool being movable relative to the valve sleeve, the method, comprising:
an operation of moving the valve spool from a valve-closed position to a valve-opened position, the valve spool is imparted with a running start before the valve spool permits flow of the pressurized hydraulic fluid from the valve sleeve.

27. A molded article manufactured by the method of claim 26.

28. A valve controller performing a method of a molding system having a hydraulic valve including: (i) a valve sleeve being configured to convey a pressurized hydraulic fluid, and (ii) a valve spool being movable relative to the valve sleeve, the method, comprising:
an operation of moving the valve spool from a valve-closed position to a valve-opened position, the valve spool is imparted with a running start before the valve spool permits flow of the pressurized hydraulic fluid from the valve sleeve.

29. A molded article manufactured by the valve controller of claim 28.

30. A hydraulic valve of a molding system, the hydraulic valve comprising:
a valve sleeve being configured to convey a pressurized hydraulic fluid; and
a valve spool being movable relative to the valve sleeve, once the valve spool is made to move from a valve-closed position to a valve-opened position, the valve spool is imparted with a running start before the valve spool permits flow of the pressurized hydraulic fluid from the valve sleeve.
